(19) United States
(12) Patent Application Publication
(10) Pub. No.: US 2008/0263921 A1
(43) Pub. Date: Oct. 30, 2008

(54) Multi Function Signs

(76) Inventor: Jae-Sik Kim, Kyungnam (KR)

Correspondence Address: BROOKS KUSHMAN P.C., 1000 TOWN CENTER, TWENTY-SECOND FLOOR, SOUTHFIELD, MI, 48075, US

(21) Appl. No.: 11/816,013

(22) PCT Filed: Feb. 9, 2006
(86) PCT No.: PCT/KR2006/000464

§ 371 Date: Oct. 19, 2007

(30) Foreign Application Priority Data
Feb. 12, 2005 (KR) 20-2005-0003775

(51) Int. Cl. G09F 11/10; G09F 19/22

(52) U.S. Cl. 40/407; 40/606.1; 40/514; 40/515; 40/546

(57) ABSTRACT

Disclosed herein is a multifunctional signboard having a window function. The signboard is constructed so that a film (2) is provided between double glass sheets (3) and liquid (1) is filled between the film (2) and the glass sheets, thus achieving an effect as if the film (2) were impregnated with the liquid, and preventing the film (2) from shimmering due to the refractive indices of the glass sheets and air, therefore serving as a visual device that causes the double glass sheets (3) and the film (2) to be perceived as one, and which is constructed so that a transparent film or a film (2) on which various patterns are printed is wound around take-up rolls (4) and is driven vertically or horizontally, thus expressing a desired degree of transparency or various designs, therefore variously altering indoor and outdoor environments.

### TECHNICAL FIELD

The present invention relates to a multifunctional signboard having a window function, which is constructed so that a film 2 is provided between double glass sheets 3 and liquid 1 is filled between the film 2 and the glass sheets, thus achieving an effect as if the film 2 were impregnated with the liquid, and preventing the film 2 from shimmering due to the refractive indices of the glass sheets and air, therefore serving as a visual device that causes the double glass sheets 3 and the film 2 to be perceived as one, and which is constructed so that a transparent film or a film 2 on which various patterns are printed is wound around take-up rolls 4 and is driven vertically or horizontally, thus expressing a desired degree of transparency or various designs, therefore variously altering indoor and outdoor environments.

### BACKGROUND ART

Generally, a conventional building uses a window comprising double glass sheets to prevent the loss of heat through the window. The double glass sheets comprise a vacuum therebetween, thus preventing the loss of heat through the glass sheets.

Such double glass sheets can prevent the loss of heat to some extent. However, in the case of the window comprising the double glass sheets, a curtain, blinds, or a sun shielding film must be provided on glass sheets so as to control the passage of sunlight. However, the window is problematic in that it is impossible to vary the transmittance or color thereof, and additional equipment is required. Further, in order to provide special effects, such as an advertising effect, to the window, a graphic advertising film or sheet may be attached to the window of a building. However, the conventional building window or signboard retains the same design throughout its entire life span, and so is monotonous.

In addition to such equipment, a smart window (SPD) to which electricity is applied to control the transmittance thereof, and a device for injecting various colors of liquid into the space between double glass sheets have been developed so as to control the color of a window. However, they are problematic in that it is impossible to realize a completely transparent state or a completely opaque state, and to provide various colors and designs.

Further, a device which is constructed so that blinds or a film is inserted between double glass sheets of a window and is driven by a motor has been considered. However, the device is problematic in that it cannot provide a high degree of transparency or clearly show images due to shimmer of the film.

### DISCLOSURE OF INVENTION

### Technical Problem

Accordingly, the present invention has been made keeping in mind the above problems occurring in the prior art, and an object of the present invention is to provide a multifunctional signboard having a window function, in which a film 2 is inserted into space between double glass sheets 3, and liquid is filled between the film 2 and glass sheets, so that the film is impregnated with the liquid, thus preventing the film from shimmering due to the difference in refractive index between the glass sheets and the air present between the double glass sheets, and allowing the double glass sheets 3, the liquid 1, and the film 2 to be perceived as one, therefore accomplishing a visual effect which provides clear and clean images.

Another object of the present invention is to provide a multifunctional signboard having a window function, in which a pattern having various degrees of transparency and various designs is printed on a film 2 inserted between double glass sheets 3, and the film 2 is wound around take-up rolls 4 to be moved vertically or horizontally, thus enabling the selection of various degrees of transparency and designs, as desired.

A further object of the present invention is to provide a multifunctional signboard having a window function, which is capable of controlling the temperature of liquid filled between double glass sheets, thus having an air conditioning function, and saving energy.

### Technical Solution

In order to accomplish the object, the present invention provides a multifunctional signboard, in which a film 2 on which a pattern having various degrees of transparency and designs is printed is inserted into space defined between double glass sheets 3, transparent liquid is filled between the film 2 and glass sheets so that the film is impregnated with the liquid, and a frame 6 of a sealing means is installed on the edge of the glass sheets, thus preventing the leakage of liquid 1.

Further, in order to accomplish another object, the present invention provides a multifunctional signboard, in which a film 2 is wound around a take-up roll 4 provided in a frame of a sealing means, and the film is moved by rotating the take-up roll using a motor, thus expressing various patterns or various degrees of transparency of the film.

Furthermore, in order to accomplish a further object, the present invention provides a multifunctional signboard, in which a liquid inlet/outlet port is installed in a frame of a sealing means, and a heat exchanger is installed in the liquid inlet/outlet port to perform a heat exchanging process using cold or hot water supplied from the exterior, thus controlling the temperature of filled liquid, therefore having an air conditioning function and saving energy.

The present invention constructed as such will be described below with reference to the accompanying drawings.

FIG. 1 is a sectional view illustrating a multifunctional signboard, according to an embodiment of the present invention,

FIG. 2 is a perspective view illustrating the multifunctional signboard of FIG. 1,

FIG. 3 is a front view illustrating the multifunctional signboard of the invention,

FIG. 4 is a sectional view showing double films, and

FIG. 5 is a view showing the configuration of the film wound around the take-up rolls.

The present invention will be described below with reference to FIGS. 1 to 3.

Referring to FIG. 1, two or more transparent sheets 3 constituting a window define a predetermined receiving space. Liquid 1 and a film 2 are accommodated in the receiving space. Frames 6 are installed at opposite ends of the transparent sheets 3 to prevent liquid from leaking from the receiving space, and define space for receiving take-up rolls 4 and motors for driving the take-up rolls 4. The side surfaces of the transparent sheets 3 and the frames 6 are sealed using a suitable method, for example, a method using rubber packing or a welding method.

The liquid 1 is liquid such as water, which is transparent. A predetermined composition, for example, an antifreeze solution, an antiseptic substance, or a coloring solution, may be added to the liquid so as to maintain a predetermined temperature, a hygienic state, or a desired color.

Further, a liquid inlet/outlet port 7 is formed at a predetermined position in the frame 6 to supply, discharge, and circulate the liquid 1. The circulating liquid absorbs or transmits energy from or to seawater, underground water, rainwater, waste water, and other heat sources via a heat exchanger, thus cooling or heating air. That is, in the winter season, the liquid absorbs heat from hot water, and circulates at a high temperature, thus warming air in a room. Conversely, in the summer season, the liquid transmits heat to cold water, and circulates at a low temperature, thus cooling air in a room. In this way, heat loss from a window of a building can be fundamentally prevented. That is, the invention provides a cooling or heating effect, like clothes protecting a person's body.

The heat source used in the heat exchange process may utilize natural resources which are harmless to the environment. That is, seawater, underground water, rainwater, or waste water is purified and circulated so as to be used for heating or cooling air. Thereby, the invention is economically efficient. Especially in the case of underground water, the underground water maintains an average temperature of 22° C. throughout the year. Thus, by circulating underground water, the indoor temperature can be maintained at a temperature similar to that of underground water.

As shown in FIG. 5, the film 2 is wound around upper and lower take-up rolls 4 or left and right take-up rolls 4. The take-up rolls 4 are manually driven using a rotating handle or a rotating line, until a desired portion of the film 2 appears. Further, according to the present invention, a motor 5 is provided around each take-up roll 4, thus enabling semi-automatic rotation of the take-up roll in opposite directions using a switch, until a desired portion of the film 2 appears. Further, the film 2 moved by each motor may be automatically remote-controlled by a film position sensor or a timing belt, so that a desired portion of the film appears.

Further, a construction, like an aquarium, may be provided in the receiving space defined between the double glass sheets or between the transparent sheets. For example, the function of forming water drops may be provided on the lower frame 6, so that the invention may have the function of an aquarium having a varying background.

According to the present invention, a heat collecting plate or a storage battery using sunlight may be provided on the film 2 or each frame 6 to transmit heat to the liquid 1 stored in the receiving space, thus cooling or heating air in a room. Further, a device driving the film 2 and a lamp may be provided inside or outside each frame 6 so that the invention can be used even at night.

FIG. 4 is a sectional view illustrating the structure of double films. The films and the take-up rolls are doubly provided, so that the design of the signboard may be changed using both surfaces thereof. According to the internal or external environment of a building, various designs may be selected.

Further, the double glass sheets 3 or the transparent sheet may be provided in two, three, or more layers, so that the signboard of the invention can be more efficiently used. The signboard of the invention may be applied to all or part of a building, an airplane, a ship, a car, a train, a greenhouse, a display, or a building interior.

FIG. 5 is a view showing an example of a film. Various desired designs are printed on the film. The film is arranged to be suitable for the size of the double glass sheets. For example, the film has three stages, that is, a completely transparent stage, a semi-transparent stage, and an opaque stage. The film has various colors, as necessary. Further, various advertisements and designs are printed on the film, thus producing various screens.

The film 2 may comprise a transparent part, parts on which various designs are printed, a sheet, or a screen, thus having varying designs. The screen may be used for business purposes in a building, using a projector. A rear screen may display a design or a motion picture to the outside. In addition to the above-mentioned materials, any material may be used as long as it may be wound around the take-up roll and may retain its durability in liquid.

As described above, the present invention comprises liquid filled between double glass sheets and a film placed in the liquid, thus eliminating a refraction phenomenon that causes the film to shimmer. Thus, a visual appearance is generated as if the film and the liquid were integrated into a single structure and the film were not present, so that a clear view is ensured.

As such, the present invention overcomes the problem occurring when only the film is provided between the double glass sheets. That is, when only the film is provided between the double glass sheets, because of the shimmer of the film, a person visually perceives that the film is installed between the double glass sheets. Thus, it is difficult to ensure a transparent view which is an indispensable requisite of a window.

While a preferred embodiment of the present invention has been described, it is to be understood that modifications will be apparent to those skilled in the art without departing from the spirit of the invention.

Although the preferred embodiment according to the present invention has been disclosed with reference to the accompanying drawings, the invention is not limited to the embodiments illustrated in the drawings, and those skilled in the art will appreciate that various modifications, additions and substitutions are possible, without departing from the scope and spirit of the invention as disclosed in the accompanying claims.

### ADVANTAGEOUS EFFECTS

According to the present invention, liquid 1 and a film 2 are provided in space defined between double glass sheets 3, so that the liquid 1 prevents refraction by the film 2, and thus the film 2 is prevented from shimmering. Therefore, the film 2 and the double glass sheets 3 are perceived as if they were one, so that a perfectly clear and clean view is ensured.

Further, when transparency, which is important for a window, is required, a transparent film is disposed, so that a clear and clean view is ensured as if the film 2 and the liquid 1 were not present.

As such, according to the present invention, liquid 1 and a film 2 are provided together between double glass sheets, thus shielding heat or noise from an exterior, and heating or cooling air in a room in the winter or summer season, in addition to saving energy.

By moving the film 2, transparency and a design are selected to be suitable for the surrounding environment and the intended purpose. Thereby, it is easy to control the transmittance of sunlight and apparent transparency, and the invention can appropriately control the admittance of light and heat according to the indoor environment. Therefore, a pleasant environment can be conveniently obtained.

Further, various advertisements and super-graphics can be expressed on the outer portion of a building using the invention. The invention may serve as a decorative graphic, a curtain, or an aquarium in a room. That is, merely by replacing the film with another one, the content of the film can be conveniently changed, so that productivity is increased, and it is efficient in view of economics.

### BRIEF DESCRIPTION OF THE DRAWINGS

FIG. 1 is a sectional view illustrating a multifunctional signboard, according to an embodiment of the present invention;

FIG. 2 is a perspective view illustrating the multifunctional signboard of FIG. 1;

FIG. 3 is a front view illustrating the multifunctional signboard of the present invention;

FIG. 4 is a sectional view showing double films; and

FIG. 5 is a view showing the configuration of the films wound around the take-up rolls.

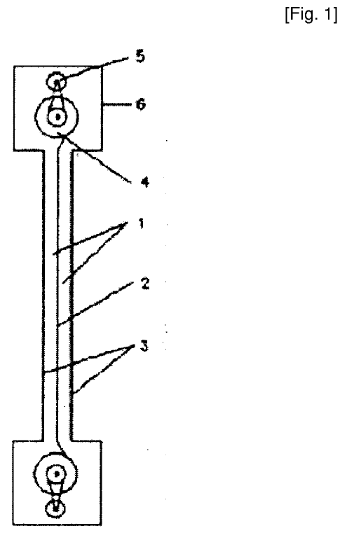

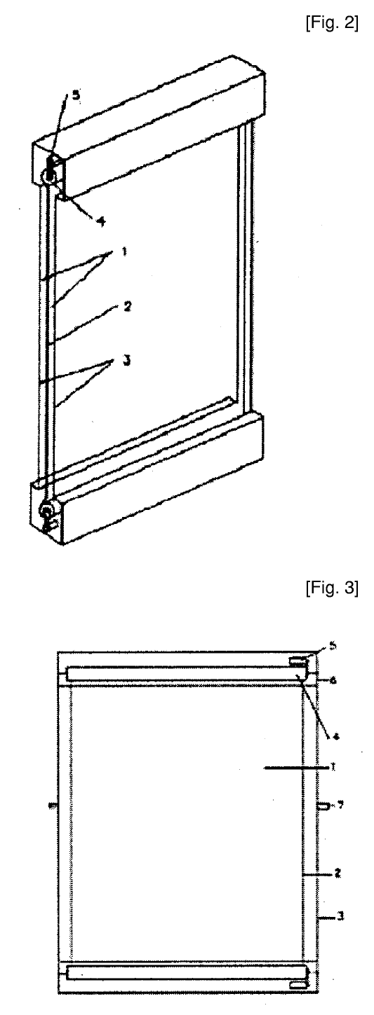

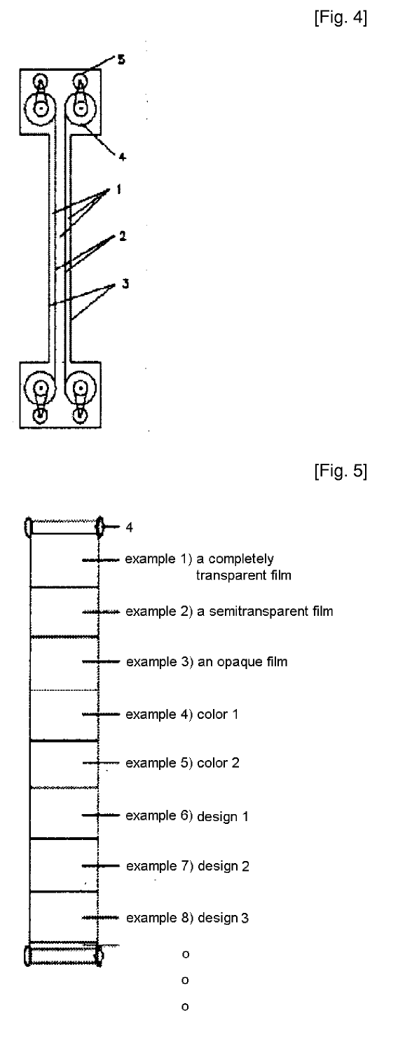

1. A multifunctional signboard, wherein two or more transparent sheets comprising double glass sheets define a predetermined receiving space, liquid and a film are accommodated in the receiving space, and sealing means is provided on each of opposite ends of the transparent sheets so as to prevent the liquid from leaking from the receiving space.

2. The multifunctional signboard according to claim 1, wherein a take-up roll for winding the film and driving means for driving the take-up roll are installed in a frame, so that a desired portion of the film appears resulting from operation of the driving means.

3. The multifunctional signboard according to claim 1, wherein a liquid inlet/outlet port is formed at a predetermined position in the frame to supply, discharge, and circulate the liquid, the circulating liquid absorbing or transmitting energy from or to seawater, underground water, rainwater, waste water, and other heat sources, via a heat exchanger, so as to be used for heating or cooling air in a room.

4. The multifunctional signboard according to claim 2, wherein the film and the take-up roll are doubly provided, thus enabling changing of a design using both surfaces.

5. The multifunctional according to claim 1, wherein a storage battery using sunlight is provided on the film or the frame, thus driving the film using power stored in the storage battery.

6. The multifunctional signboard according to claim 1, wherein a lamp is provided inside or outside the frame so as to enable use of the signboard at night.

7. The multifunctional signboard according to claim 1, wherein the signboard is used as a window of a building.

8. The multifunctional signboard according to claim 2, wherein the signboard is used as a window of a building.

9. The multifunctional signboard according to claim 3, wherein the signboard is used as a window of a building.

10. The multifunctional signboard according to claim 4, wherein the signboard is used as a window of a building.

11. The multifunctional signboard according to claim 5, wherein the signboard is used as a window of a building.

12. The multifunctional signboard according to claim 6, wherein the signboard is used as a window of a building.
